(19) United States
(12) Patent Application Publication
(10) Pub. No.: US 2022/0143847 A1
(43) Pub. Date: May 12, 2022

(54) AGRICULTURAL ROBOT FOR A VERTICAL FARMING UNIT

(71) Applicant: ADVANCED INTELLIGENT SYSTEMS INC., Burnaby (CA)

(72) Inventors: Farhang Bidram, West Vancouver (CA); Shahram Pourazadi, Burnaby (CA); Keith Chow, Richmond (CA)

(21) Appl. No.: 17/435,522

(22) PCT Filed: Feb. 28, 2020
(86) PCT No.: PCT/IB2020/051729

§ 371 Date: Sep. 1, 2021

Related U.S. Application Data
(60) Provisional application No. 62/812,924, filed on Mar. 1, 2019.
(60) Provisional application No. 62/814,519, filed on Mar. 6, 2019.

(51) Int. Cl. B25J 19/00; B25J 5/00; A01G 9/14

(52) U.S. Cl. CPC B25J 19/005; B25J 19/0025; A01G 9/143; B25J 5/007

(57) ABSTRACT

An agricultural robot is disclosed, the agricultural robot comprising a chassis comprising a plurality of ground-engaging mechanisms for propelling the robot in a direction of travel; a supply module mounted on the chassis and comprising a fluid providing unit, a power providing unit, a supply interface operatively connected to the fluid providing unit and to the power providing unit and for providing at least one of fluid and power; and a controller for operating the plurality of ground-engaging mechanisms and the supply interface.

### CROSS REFERENCE TO RELATED APPLICATION

The present patent application claims priority on U.S. Patent Application No. 62/812,924, filed on Mar. 1, 2019, by the present Applicant. This application further claims priority on U.S. Patent Application No. 62/814,519, filed on Mar. 6, 2019, by the present Applicant

### TECHNICAL FIELD

One or more embodiments of the invention relate to the field of robotics. More precisely, one or more embodiments of the invention pertain to an agricultural robot.

### BACKGROUND

Container-based plants may be grown in indoor greenhouses where plants are provided with a controlled environment suitable for the plants growth. In recent years, there is a growing number of technologies offered for improving efficiency, productivity, land use, labor usage, and cost expenditure in farming plants and crops. For example, robotic and automation systems have been introduced to carry out certain farming tasks autonomously or semi-autonomously.

In indoor potted plant nurseries, usually the potted plants are grown while being horizontally distributed across a level surface which consumes a large space. Assuming abundance and availability of cheap land, laying out potted plants horizontally on a surface level seems reasonable, however, in cases where land is not sufficiently available or reasonably priced, potted plants may be grown in vertically oriented levels.

Vertical farming, in which plants are grown in generally a vertical structure, is mainly used to grow plants in an efficient way in controlled environments with limited space.

Although vertical farming is usually associated with aeroponic or hydroponic farming methodologies, vertical farming may also be used for growth of potted plants as well. A mobile collapsible multi-shelf apparatus may be used to facilitate cultivating potted plants. Using such multi-shelf apparatus improves the efficiency and productivity of greenhouse nurseries by taking advantage of the vertical space while providing mobility on-demand for batches of potted plants. The collapsible shelves of such multi-shelf apparatus enables manual or automated loading and unloading of potted plants in low elevations which in turn improves operational safety and ease.

Additionally, due to the mobility and self-containability of an individual multi-shelf apparatus or a plurality of multi-shelf apparatuses, the multi-shelf apparatus may be used to facilitate growth of plants in different stages of plant's growth cycle. For example, the plants can undergo one or more stages of their growth facilitated by the multi-shelf apparatus, while being shipped to (and/or stored in) a destination, such as a retailer, which will result in improved freshness and durability of the products used by consumers.

While the multi-shelf apparatus may be mobile, it will be appreciated by the skilled addressee that sources used for operating and servicing the multi-shelf apparatus are usually not static. For instance, fluid reservoirs, such as large water tanks, are static and dispensing fluid from a reservoir to a multi-shelf apparatus requires tubing. Power from the local power grid is also not readily mobile and may require lengthy wiring to reach and power up the multi-shelf apparatus.

There is a need for at least one of a method and a system that will overcome at least one of the above-identified drawback.

### BRIEF SUMMARY

According to a broad aspect, there is disclosed an agricultural robot comprising a chassis comprising a plurality of ground-engaging mechanisms for propelling the robot in a direction of travel; a supply module mounted on the chassis and comprising a fluid providing unit, a power providing unit, a supply interface operatively connected to the fluid providing unit and to the power providing unit and for providing at least one of fluid and power; and a controller for operating the plurality of ground-engaging mechanisms and the supply interface.

In accordance with one or more embodiments, the fluid providing unit comprises a fluid reservoir and the supply interface comprises a fluid outlet operatively connected to the fluid reservoir.

In accordance with one or more embodiments, the supply interface further comprises a fluid inlet operatively connected to the fluid reservoir.

In accordance with one or more embodiments, the supply interface comprises a robotic arm comprising an end effector and the fluid outlet is mounted at the end effector of the robotic arm.

In accordance with one or more embodiments, the power providing unit comprises a battery pack comprising a plurality of batteries and a power connection operatively connected to the battery pack for providing power from the battery pack.

In accordance with one or more embodiments, the supply interface comprises a robotic arm comprising an end effector and the power connection is mounted at the end effector of the robotic arm.

In accordance with one or more embodiments, the supply interface comprises at least one removable battery and a robotic arm sized and shaped for replacing a removable battery located in the vicinity of the agricultural robot with a given removable battery of the at least one removable battery.

In accordance with one or more embodiments, the robotic arm comprises an end effector comprising a standardized docking connector and each of the removable battery comprises a standardized docking port compatible with said standardized docking connector.

In accordance with one or more embodiments, the end effector further comprises guiding means for aligning the end effector with a given removable battery to manipulate.

In accordance with one or more embodiments, the guiding means comprises two support parallel members rotationally mounted to the end effector and movable between a resting position wherein the two support parallel members are in a vertical plane and an operating position wherein the two support parallel members are in an horizontal plane.

In accordance with one or more embodiments, the plurality of ground-engaging mechanisms comprise a plurality of motorized wheels.

In accordance with one or more embodiments, the controller comprises a processing unit, at least one sensor and a wireless communication device; further wherein the at least one sensor and the wireless communication device are operatively connected to the processing unit.

In accordance with one or more embodiments, the power providing unit further comprises a rotating platform for receiving a plurality of removable batteries, each facing a center of the rotating platform.

In accordance with one or more embodiments, the power providing unit further comprises a collapsible multi-shelf rack receiving a plurality of removable batteries.

According to a broad aspect, there is disclosed a system comprising at least one agricultural robot as disclosed above; at least one vertical farming unit comprising a supply interface corresponding to the supply interface of each of the at least one agricultural robot; at least one sensor located on at least one of the at least one agricultural robot and at least one of the at least one vertical farming unit, the at least one sensor for providing data indicative of a parameter of a vertical farming unit of the at least one vertical farming unit; and a controller operatively connected to the at least one agricultural robot and to the at least one sensor, the controller receiving data provided by the at least one sensor and dispatching an agricultural robot accordingly.

In accordance with one or more embodiments, the at least one sensor is selected from a group consisting of temperature sensors, humidity sensors, light sensors and nutrition sensors.

In accordance with one or more embodiments, the controller is wirelessly connected to the at least one agricultural robot and to the at least one sensor.

In accordance with one or more embodiments, the at least one agricultural robot, the at least one vertical farming unit and the at least one sensor are located on an operating site while the controller is remotely located from the operating site.

In accordance with one or more embodiments, the system further comprises a supply station for supplying an agricultural robot of the at least one agricultural robot with at least one resource.

In accordance with one or more embodiments, the at least one resource comprises power and the supply station comprises a power source.

In accordance with one or more embodiments, the power source comprises a charging station for charging power banks.

In accordance with one or more embodiments, the power source comprises a charging station for charging at least one removable battery to be carried by a given agricultural robot.

In accordance with one or more embodiments, the at least one resource comprises fluid and the supply station comprises a fluid source.

In accordance with one or more embodiments, the fluid source comprises a fluid reservoir.

According to a broad aspect, there is disclosed a method for autonomously supplying a vertical farming unit, the method comprising charging a supply module of an agricultural robot as disclosed above; receiving data of at least one vertical farming unit; displacing the agricultural robot to a given vertical farming unit of the at least one vertical farming unit; operatively connecting the agricultural robot to the given vertical farming unit; and providing at least one of fluid and power to the given vertical farming unit.

In accordance with one or more embodiments, the charging of the supply module of the agricultural robot comprises at least one of filing up a fluid reservoir and charging a power providing unit of the agricultural robot.

In accordance with one or more embodiments, the data of the at least one vertical farming unit is wireless received by a controller.

In accordance with one or more embodiments, the agricultural robot is displaced to a given vertical farming unit upon receipt of a given signal from a controller operatively connected to the agricultural robot.

In accordance with one or more embodiments, the providing of at least one of fluid and power to the given vertical farming unit comprises charging using a power bank located on the supply module of the agricultural robot.

In accordance with one or more embodiments, the providing of at least one of fluid and power to the given vertical farming unit comprises loading the given vertical farming unit with at least some charged removable battery located on the supply module of the agricultural robot.

It will be appreciated that the agricultural robot disclosed herein is of great advantage.

In fact, an advantage of the agricultural robot disclosed herein is that it may reduce or eliminate the need for lengthy wiring and tubing systems from a static fluid and from the power sources by bridging the gap between static facilities and mobile vertical farming units, increasing the mobility and modularity of vertical farming units using mobile multi-shelf apparatuses within the greenhouse space as needed.

Another advantage of the agricultural robot disclosed herein is that it can travel along with a mobile vertical farming unit as the mobile vertical farming unit is being transported between locations, for example being shipped from a nursery to a retail location, in order to continue providing power for lighting and fluid for irrigation to plants even while during transport, improving freshness and optimizing growing time.

Another advantage of the agricultural robot disclosed herein is that it may be used to provide power and fluid to plants in the case of an outage, mitigating losses in event of an emergency.

Other aspects and features will become apparent to those ordinarily skilled in the art upon review of the following description of specific disclosed embodiments in conjunction with the accompanying figures.

### BRIEF DESCRIPTION OF THE DRAWINGS

In the following, one of more embodiments of the present disclosure will be described with reference to the appended drawings. However, various embodiments of the present disclosure are not limited to arrangements shown in the drawings.

FIG. 1a is a 3D perspective, partly exploded, view of an embodiment of the agricultural robot.

FIG. 1b is a perspective view of an embodiment of the agricultural robot illustrated in FIG. 1a.

FIG. 2a is a perspective view of another embodiment of an agricultural robot.

FIG. 2b is an enlarged view of an end effector used in one embodiment of the agricultural robot shown in FIG. 2a.

FIG. 3 is a front plan view of an embodiment of a mobile vertical farming unit which may be supplied by one or more embodiments of the agricultural robot disclosed herein.

FIG. 4a is a 3D perspective view illustrating an embodiment of a mobile vertical farming unit with an embodiment of an agricultural robot.

FIG. 4b is an enlarged, 3D perspective view illustrating a removable battery being removed from a mobile vertical farming unit.

FIG. 4c is a 3D perspective view illustrating an agricultural robot removing a removable battery from the mobile vertical farming unit.

FIG. 4d is a 3D perspective view illustrating an agricultural robot inserting a removable battery into the mobile vertical farming unit.

FIG. 5 is a diagram which illustrates a system for autonomously supplying vertical farming units using one or more embodiments of the agricultural robot.

FIG. 6 is a flowchart which shows an embodiment for autonomously supplying a vertical farming unit using one of more embodiments of an agricultural robot.

FIG. 7a is a 3D perspective view illustrating an embodiment of an agricultural robot with a rotating platform.

FIG. 7b is a top plan view of the agricultural robot shown in FIG. 7a.

FIG. 8a is a 3D perspective view illustrating another embodiment of an agricultural robot.

FIG. 8b is a side view of the embodiment of the agricultural robot shown in FIG. 8a.

### DETAILED DESCRIPTION OF SPECIFIC EMBODIMENTS

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain.

The term “i.e.” and like terms mean “that is,” and thus limit the terms or phrases they explain.

The term “removable battery” and like terms mean a battery which may be removed from a location and replaced by another one. In one or more embodiments, the removable battery is rechargeable. In one or more alternative embodiments, the removable battery is not rechargeable.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

With all this in mind, one or more embodiments of the present invention are directed to an agricultural robot, a method for operating same and a system comprising an agricultural robot and at least one vertical farming unit.

It will be appreciated that in one of more embodiments, the agricultural robot is used with a vertical farming unit, such as a multi-shelf apparatus, as further explained below. Moreover, it will be appreciated that in one or more embodiments, the vertical farming unit is a mobile vertical farming unit. In an alternative embodiment, the agricultural robot is used for other farming units such as hydroponic and aeroponic units.

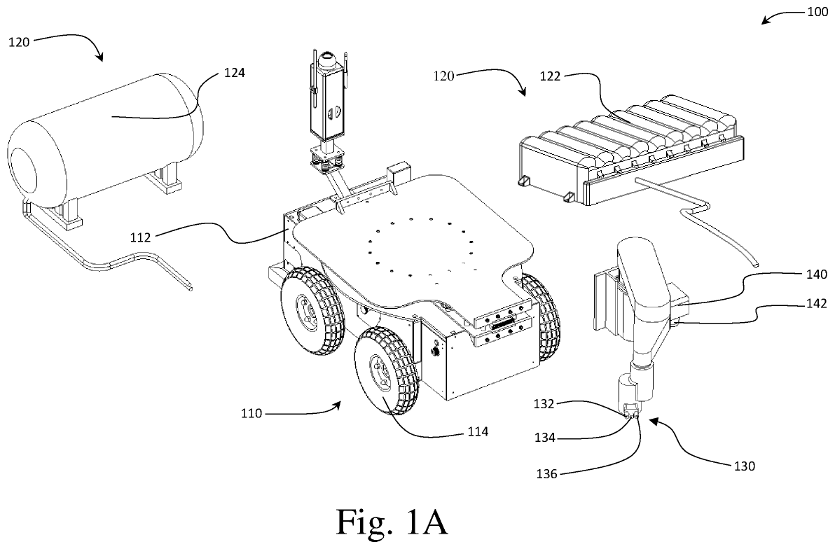

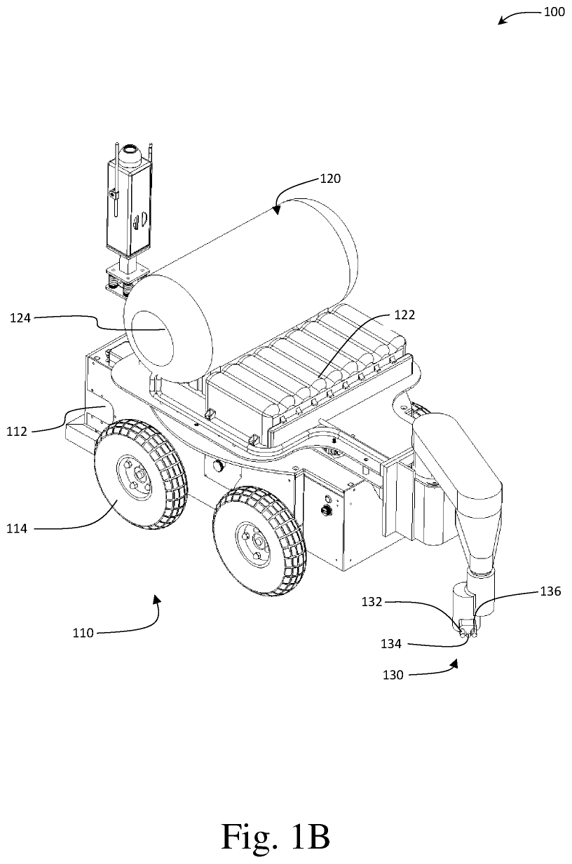

Now referring to both FIG. 1a and FIG. 1b, there is shown respectively a partly exploded view and a perspective view of an embodiment of the agricultural robot.

The agricultural robot 100 comprises a chassis 110, a supply module 120 and a controller, not shown.

More precisely, the chassis 110 comprises a plurality of ground-engaging mechanisms for propelling the agricultural robot in a direction of travel. In the embodiment shown in FIG. 1a, the plurality of ground-engaging mechanisms comprises a plurality of motorized wheels, an example of which is motorized wheel 114, secured to a body 112. More precisely and in the embodiment disclosed in FIG. 1a, the plurality of motorized wheels comprises four independently actuated wheels. Alternatively the four wheels are not independently actuated.

The skilled addressee will appreciate that various alternative embodiments may be possible for the ground-engaging mechanisms. For instance and in one alternative embodiment, the ground-engaging mechanisms comprise a continuous track such as a belt track or chain track to facilitate the agricultural robot's movement in rough terrain, for example.

The skilled addressee will further appreciate that various embodiments may be provided for the body 112.

In one embodiment, the body 112 comprises a planar surface sized and shaped for receiving the supply module 120 mounded on the chassis 110.

In fact, it will be appreciated that in one or more embodiments, the supply module 120 is used for providing a given resource to a vertical farming unit.

It will be appreciated that the supply module 120 comprises a fluid providing unit, a power providing unit, and a supply interface.

The fluid providing unit is used for providing a fluid. In one or more embodiments, the fluid comprises a liquid suitable for a vertical farming unit. In one or more embodiments, the liquid comprises water. The skilled addressee will appreciate that in an alternative embodiment, the liquid further comprises nutrients suitable for the plants located in the vertical farming unit such as chemical elements and compounds necessary for plant growth and plant metabolism. In one or more embodiments, the fluid providing unit comprises a fluid reservoir 124. It will be appreciated that the fluid reservoir 124 may comprise one or more compartments for storing fluids. The one or more compartments may be separate containers, or may be internal divisions within a single container. The one or more compartments may be interconnected to permit fluid flow from certain compartments to others, or may be separate wherein the fluid streams only mix at the outlet, for example.

Moreover, the skilled addressee will appreciate that the fluid reservoir 124 may be manufactured according to various embodiments. In one or more embodiments, the fluid reservoir is a box made from durable plastic and is manufactured by Botanicare®, for example. In other embodiments, several boxes of fluid reservoir may be connected together. The skilled addressee will appreciate that various alternative embodiments may be provided for the fluid providing unit.

The power providing unit is used for providing power to a vertical farming unit. It will be appreciated that the power may be provided according to various embodiments as further illustrated below. Moreover and in accordance with one or more embodiments, the power providing unit comprises a battery pack 122 receiving a plurality of batteries. It will be appreciated by the skilled addressee that the batteries may be of various types. In one or more embodiments, the batteries are rechargeable lithium-ion batteries manufactured by BOSCH®. The skilled addressee will appreciate that various alternative embodiments may be provided for the battery pack 122.

The supply interface is used for providing at least one of fluid and power to the vertical farming unit and is operatively connected to the fluid providing unit and to the power providing unit.

More precisely and in accordance with one or more embodiments, the supply interface comprises a fluid outlet 132, a fluid inlet 134 and a robotic arm. The fluid inlet 134 is used for providing fluid to the reservoir 124 while the fluid outlet 132 is used for providing fluid from the reservoir 124 to a vertical farming unit.

The supply interface further comprises a power connection 136. The power connection 136 is operatively connected to the battery pack 122 and is used for providing power originating from the battery pack 122. It will be appreciated that the power connection 136 may be of various types. In one or more embodiments, the power connection 136 is a 3 pin power connector manufactured by Mouser Electronics.

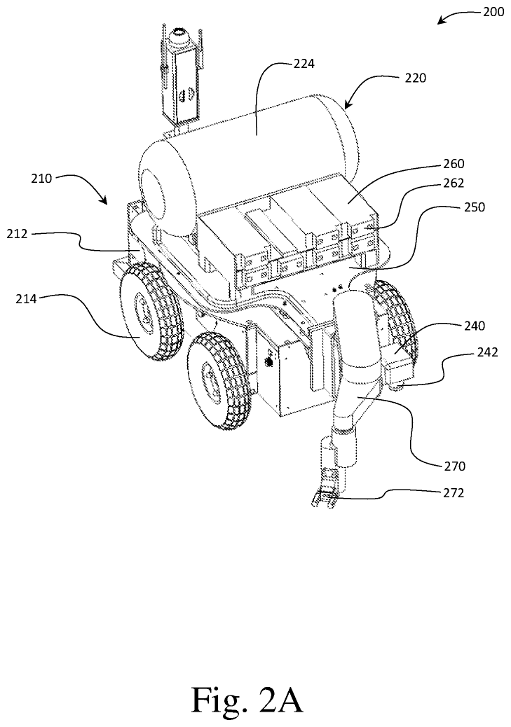

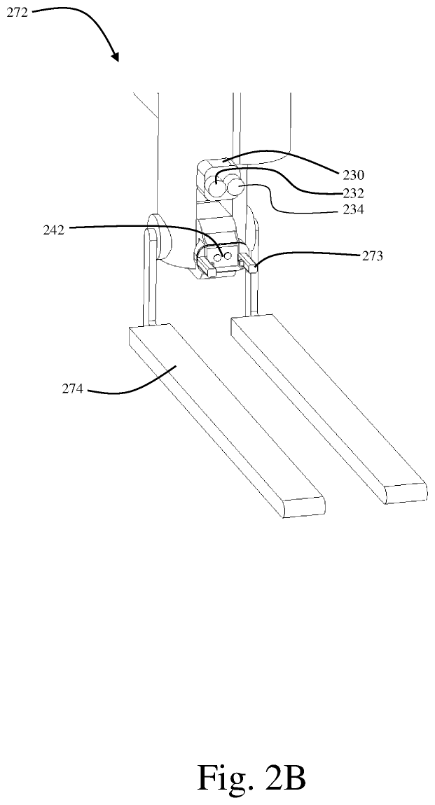

The robotic arm is used for positioning each of the fluid inlet 134, the fluid outlet 132 and the power connection 136 at a precise desired location. In one embodiment, the robotic arm is a 3 degree of freedom arm such as a 3 degree of freedom Selective Compliance Assembly Robot arm (SCARA) manufactured by EPSON®. The skilled addressee will appreciate that various alternative embodiments may be provided for the robotic arm. As further explained below and illustrated for instance at FIG. 2a, it will be appreciated that in one or more embodiments, the robotic arm is sized and shaped for replacing a removable battery located in the vicinity of the agricultural robot with a given battery of at least one removable battery.

It will be appreciated that in one or more embodiments, the fluid outlet 132, the fluid inlet 134 and the power connection 136 are mounted at an end effector of the robotic arm.

The agricultural robot 100 further comprises a controller. The controller is operatively connected to the plurality of ground-engaging mechanisms and to the supply interface. The controller is used for operating the plurality of ground-engaging mechanisms and the supply interface.

In one or more embodiments, the controller comprises a processing unit 140, at least one sensor 142 and a wireless communication device, not shown. Each of the at least one sensor 142 and the wireless communication device are operatively connected to the processing unit 140.

It will be appreciated that the processing unit 140 may be of various types. In one or more embodiments, the processing unit 140 is a NUC mini PC manufactured by Intel®.

It will be further appreciated that the at least one sensor 142 may be of various types. In one or more embodiments, the at least one sensor 142 is selected from a group consisting of optical cameras, Light Detection and Ranging (LIDAR) sensors, radars, ultrasonic sensors, GPS transceivers, UWB transceivers, Bluetooth sensors and acoustic sensors. It will be appreciated that the at least one sensor 142 is used for providing data to the processing unit 140. The skilled addressee will appreciate that the data may be used for instance for the autonomous navigation of the agricultural robot 100. It will be appreciated that the data may also be provided to a remote processing unit, not shown, operatively connected to the processing unit 140.

It will be appreciated that the wireless communication device may be of various types. In one or more embodiments, the wireless communication device is WiFi network adapter manufactured by TP-Link. In fact, it will be appreciated that the purpose of the wireless communication device is to enable a communication of the controller with at least one remote processing unit. The remote processing unit may be connected to the controller using a data network selected from a group consisting of at least one of a local area network, a metropolitan area network and a wide area network. In one embodiment, the wide area network comprises the Internet.

Now referring to FIG. 2a, there is shown another embodiment of an agricultural robot 200. In this embodiment, the power providing unit of the agricultural robot 200 comprises a transport surface 250 adapted for carrying a plurality of removable batteries 260.

It will be appreciated that the plurality of removable batteries 260 may be of various types. In one or more embodiments, the plurality of removable batteries 260 are rechargeable lithium-ion batteries manufactured by BOSCH®.

In fact, it will be appreciated that the transport surface 250 comprises a structure adapted for facilitating the storage and the transport of the plurality of removable batteries 260. For instance, the structure may comprise at least one of rails, a rack, shelf pins, etc. It will be appreciated that in the embodiment disclosed in FIG. 2a, the plurality of removable batteries 260 are stored both horizontally and vertically. The skilled addressee will appreciated that various embodiments of the structure may be provided for enabling the storage and the transport of the plurality of removable batteries 260.

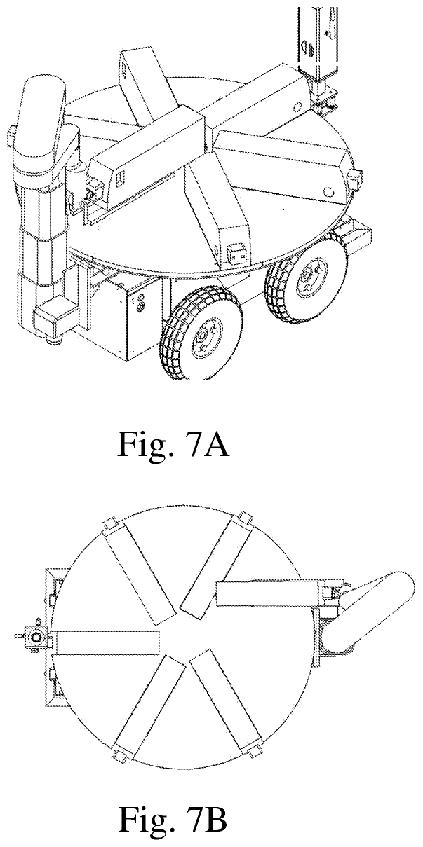

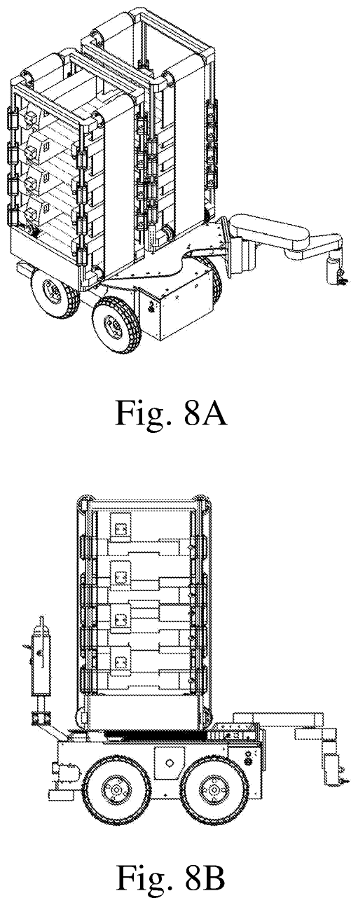

In fact, it will be appreciated that in one or more embodiments, the transport surface 250 of the power providing unit comprises a dynamically accessible storage for enabling a storing of a larger number of removable batteries in the structure. For instance and in accordance with an embodiment, the transport surface 250 is provided with a rotating platform or a collapsible multi-shelf racks to increase such carrying capacity. Now referring to FIGS. 7a and 7b, there is shown an embodiment of such a rotating platform while FIGS. 8a and 8b disclose a collapsible multi-shelf racks. As shown in FIGS. 7a and 7b, the plurality of removable batteries 260 are placed on the rotating platform such that they each face the center of the rotating platform. In FIGS. 8a and 8b, the plurality of removable batteries 260 are placed on each rack of the collapsible multi-shelf racks. The skilled addressee will appreciate that various alternative embodiments may be provided for the storing the plurality of removable batteries 260.

It will be appreciated that each of the removable batteries 260 comprises at least a standardized docking port 262 and a standardized power interface (not shown) to facilitate autonomous removal and installation of the plurality of removable batteries 260. The agricultural robot 200 also comprises a robotic arm, an embodiment of which is the manipulator arm 270, comprising an end effector 272 compatible with the standardized docking port 262.

Now referring to FIG. 2b, there is shown an end effector 272 used in one embodiment of the agricultural robot 200. The end effector 272 comprises a standardized docking connector 273 compatible with a standardized docking port 262 of the plurality of removable batteries 260. It will be appreciated that the end effector 272 further comprises, in one or more embodiments, guiding means 274. The purpose of the guiding means 274 is to align the end effector 272 to articles to be manipulated. The guiding means 274 may further be used for providing an additional support for carrying an article, such as a removable battery, as further explained below. It will be appreciated that in one or more embodiments the guiding means 274 are static in the sense that they do not move with respect to the end effector 272 while in one or more other embodiments, the guiding means 274 may move with respect to the end effector 272. For instance, the guiding means 274 may move using a rotation movement between a resting position in which they are not used and an operating position in which they extend horizontally and are being used.

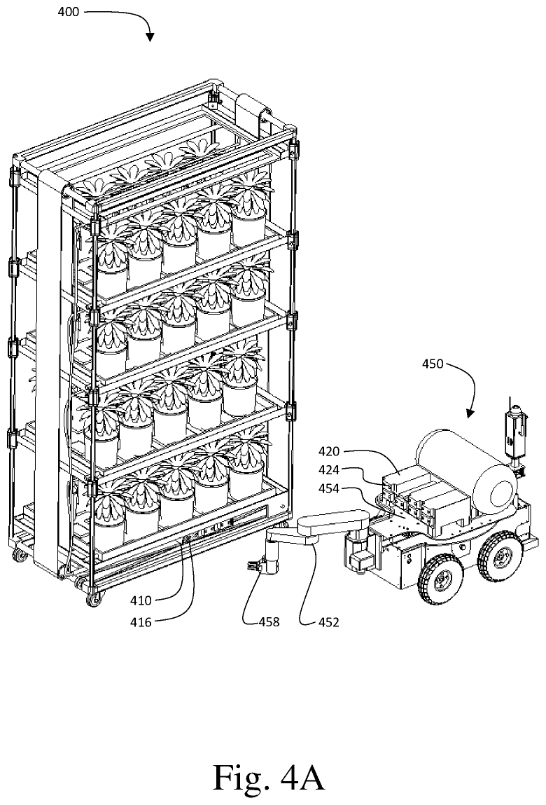

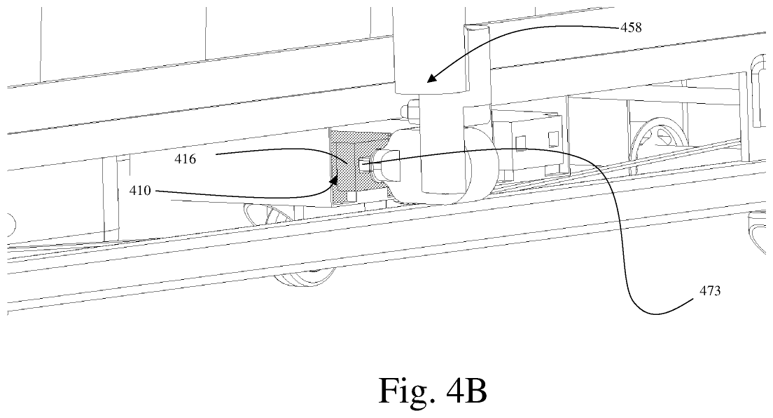

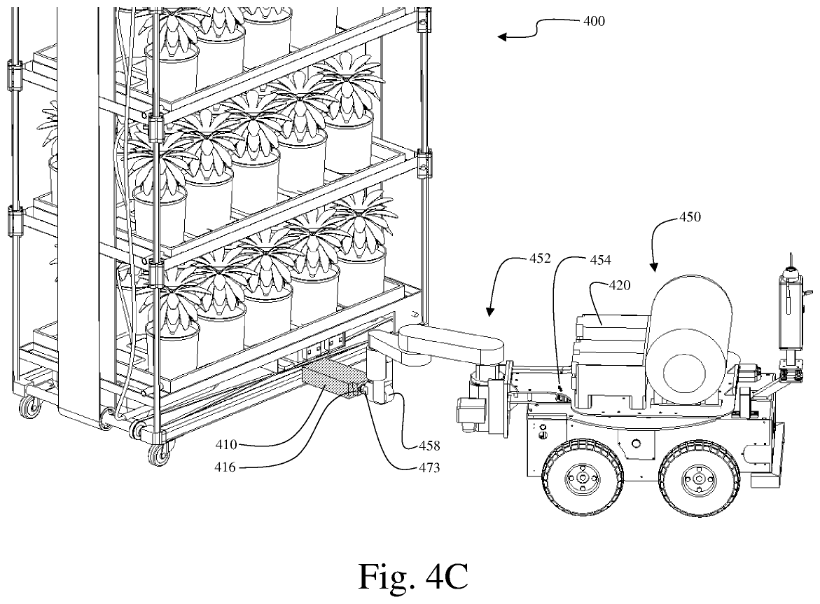

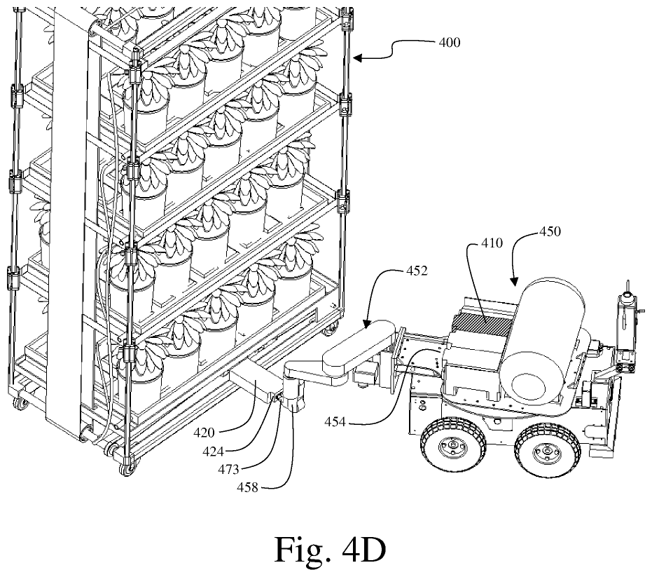

It will be appreciated that the guiding means 274 may be of various types. For instance and as disclosed in FIG. 2b, the guiding means 274 may comprise two support parallel members rotationally mounted to the end effector 272 and movable between the resting position wherein the two support parallel members are in a vertical plane and an operating position wherein the two support parallel members are in an horizontal plane. The skilled addressee will appreciate that the plurality of removable batteries 260 may be provided with corresponding channels sized and shaped for receiving at least one portion of the two support parallel members of the guiding means 274. It will be further appreciated that in the embodiments disclosed in FIG. 2a and FIGS. 4a-d, the standardized docking connector 273 alone is sufficient for providing the aforementioned functions and the guiding means 274 is optional.

It will be appreciated that the end effector 272 may also comprise the supply interface 230, and may comprise, for instance, a fluid outlet 232 and a fluid inlet 234.

It will be appreciated that in one or more embodiments, the end effector 272 further comprises at least one sensor 242. It will be further appreciated that the at least one sensor 242 may be of various types. In one or more embodiments, the at least one sensor 242 is selected from a group consisting of optical cameras, Light Detection and Ranging (LIDAR) sensors, radars, ultrasonic sensors, GPS transceivers, UWB transceivers, Bluetooth sensors and acoustic sensors. It will be appreciated that the at least one sensor 242 is used for providing data to the processing unit 240. The skilled addressee will appreciate that the data may be used for instance for the autonomous navigation of the agricultural robot 200 and for positioning the end effector 272 in front of a given target. It will be appreciated that the data may also be provided to a remote processing unit, not shown, operatively connected to the processing unit 240. The remote processing unit may be connected to the processing unit 240 using a data network selected from a group consisting of at least one of a local area network, a metropolitan area network and a wide area network. In one embodiment, the wide area network comprises the Internet.

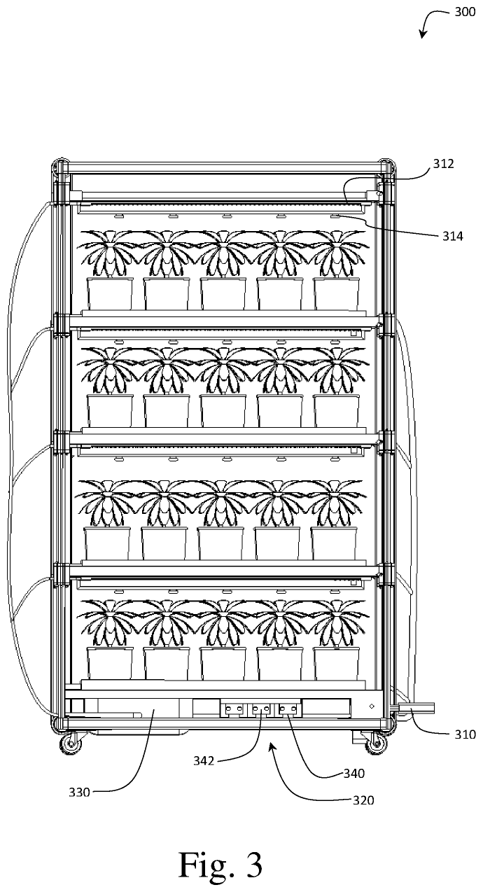

Now referring to FIG. 3, there is shown an embodiment of a mobile vertical farming unit 300. In this embodiment, the mobile vertical farming unit 300 comprises a supply interface 310 adapted to be operatively connected to the supply interface 130 of the agricultural robot 200 as further explained below.

The mobile vertical farming unit 300 further comprises a lighting system 312 and an irrigation system 314 for providing respectively light and liquid to a plurality of plants located in the mobile vertical farming unit 300.

The lighting system 312 and the irrigation system 314 systems are operatively connected to the supply interface 310 of the mobile vertical farming unit 300. It will be appreciated by the skilled addressee that the purpose of the lighting system 312 is to provide light to the plants according to a given schedule while the purpose of the irrigation system 314 is to deliver a fluid to the plants.

It will be appreciated that the lighting system 312 may be of various types. For instance and in one embodiment, the lighting system 312 comprises vertical farming LED modules and is manufactured by Philips®. The skilled addressee will appreciate that various alternative embodiments may be provided for the lighting system 312.

Similarly, it will be appreciated that the irrigation system 314 may be of various types. For instance and in one embodiment, the irrigation system 314 comprises micro drip irrigation sprinklers and is manufactured by Mister Landscaper®. The skilled addressee will appreciate that various alternative embodiments may be provided for the irrigation system 314.

It will be appreciated that the mobile vertical farming unit 300 further comprises a power bank 320 and a fluid reservoir 330. The power bank 320 is operatively connected to the lighting system 312 while the fluid reservoir 330 is operatively connected to the irrigation system 314. In one embodiment, the power bank 320 comprises at least one removable battery 340 of the type of the plurality of removable batteries 260 of the agricultural robot 200, having for instance a standardized docking port 342 and a standardized power interface, not shown. In such embodiment, the agricultural robot 200 may use its manipulator arm 270 to replace a depleted removable battery 340 of the mobile vertical farming unit 300 with a charged removable battery of the plurality of removable batteries 260 carried by the agricultural robot 200.

It will be appreciated that the agricultural robot 100 may connect its supply interface 130 to the corresponding supply interface 310 of the mobile vertical farming unit 300 in order to respectively supply power and fluid to respectively the lighting system 312 and to the irrigation 314 systems, or to charge the power bank 320 and/or fluid reservoir 330. Now referring to FIG. 4a, there is shown an embodiment of a mobile vertical farming unit 400 of the type of the mobile vertical farming unit shown in FIG. 3.

In this embodiment, the mobile vertical farming unit 400 comprises a removable battery 410, having a standardized power interface (not shown) and a standardized docking port 416. The removable battery 410 is operatively connected to the mobile vertical farming unit 400, for example, by engaging the standardized power interface with a corresponding power interface of the mobile vertical farming unit 400 (not shown).

It will be further appreciated that an agricultural robot 450 is also shown in FIG. 4a. In this embodiment, the agricultural robot 450 comprises a manipulator arm 452, which is an embodiment of a robotic arm, having an end effector 458. The agricultural robot 450 is further shown carrying a removable battery 420 to be used by the mobile vertical farming unit 400 on a transport surface 454. The removable battery 420 comprises a power interface (not shown) and a docking port 424.

Now referring to FIG. 4b, it will be appreciated that there is illustrated that the removable battery 410 is being removed from the mobile vertical farming unit 400 by the agricultural robot 450 by engaging the standardized docking connector 473 of the end effector 458 of the manipulator arm 452 of the agricultural robot 450 with a corresponding standardized docking port 416 located on the removable battery 410 of the mobile vertical farming unit 400.

It will be appreciated that the agricultural robot 450 may then disengage the replaceable battery 410 by performing a given motion, an example of which is a linear translation, and then remove the removable battery 410. The removable battery 410 removed may then be stored on the transport surface 454 of the agricultural robot 450 to be carried back to a charging station for recharging purposes.

Now referring to FIG. 4c, it will be appreciated that the removable battery 410 has been removed from the mobile vertical farming unit 400 by the agricultural robot 450 by engaging the standardized docking connector 473 of the end effector 458 of the manipulator unit 452 of the agricultural robot 450 with the standardized docking port 416 on the removable battery 410 and performing the given motion mentioned above. The agricultural robot 450 may then place the removable battery 410 onto the transport surface 454 in an empty space dedicated for a removable battery, not shown.

Now referring to FIG. 4d, it will be appreciated that the agricultural robot 450 can then proceed to attach a charged removable battery 420 by engaging the docking connector 473 with a standardized docking port 424 on the charged removable battery 420, and engaging the power interface of the charged removable battery 420 with the power interface of the mobile vertical farming unit 400 by performing a second given motion, an example of which is a linear translation in an opposite direction of the first given motion. It will be appreciated that once the charged removable battery 420 is placed in position, the agricultural robot 450 then disengages the standardized docking connector 473 of the end effector 458 from the standardized docking port 424 of the removable battery 420. During this process, the previous removable battery 410 may be stored on the transport surface 454 of the agricultural robot 450.

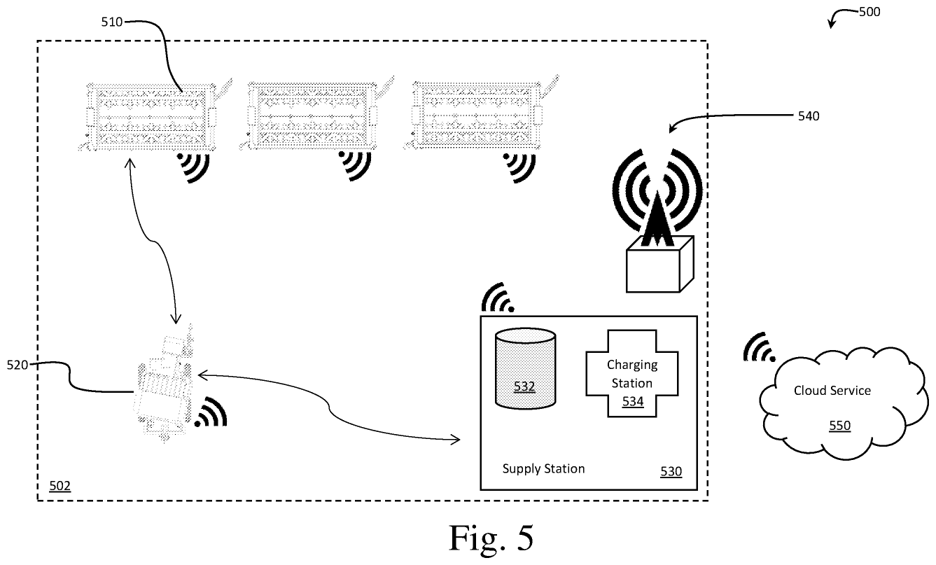

Now referring to FIG. 5, there is shown an embodiment of a system 500 for supplying a vertical farming unit. It will be appreciated that in this embodiment the vertical farming unit is a mobile vertical farming unit.

The system 500 comprises an operating site 502 where is located at least one mobile vertical farming unit 510, an example of which is the mobile vertical farming unit 300 shown in FIG. 3. The system 500 also comprises at the operating site 502 at least one agricultural robot 520, such as the agricultural robot 100 or 200 shown in respectively in FIGS. 1a and 2a.

The system 500 further comprises a supply station 530 located at the operating site 502. The purpose of the supply station 530 is to cater to the needs of the at least one mobile vertical farming unit 510. More precisely, the supply station 530 is used for supplying an agricultural robot of the at least one agricultural robot 520 with at least one resource.

In one or more embodiments, the at least one resource comprises fluid and the supply station 530 comprises a fluid source 532. It will be appreciated that the fluid source 532 may be of various types. In one or more embodiments, the fluid source 532 comprises a large fluid reservoir for at least one of holding and mixing liquids and nutrients.

In one or more embodiments, the at least one resource comprises power and the supply station 530 comprises a power source 534. It will be appreciated that the power source 534 may be of various types. In one or more embodiments, the power source 534 comprises a charging station for charging a power bank of the at least one agricultural robot 520, or a charging station for charging the removable batteries carried by the at least one agricultural robot 520.

The system 500 also comprises a controller 540. The controller 540 is used for monitoring and managing the system 500. More precisely, it will be appreciated that the controller 540 is used for monitoring the status of the at least one mobile vertical farming unit 510, including, for example, an amount of power and or liquid left. The controller 540 is also used for dispatching an agricultural robot to a given mobile vertical farming unit of the at least one mobile vertical farming unit 510 depending on its needs. It will be appreciated that in one or more embodiments, the controller 540 is located in the operating site 502. In such embodiment, the controller 540 comprises a server. In one or more other embodiments, the controller 540 is located on an agricultural robot of the at least one agricultural robot 520. In one or more other embodiments, the controller 540 is located at a mobile vertical farming unit. In another alternative embodiment, the controller is a processing device located in the cloud, such as cloud server 550. In such embodiment, the controller is remotely located from the operating site 502. The controller 540 may be accessed using a data network selected from a group consisting of a local area network, a metropolitan area network and a wide area network. In one embodiment, the data network comprises the Internet.

It will be appreciated that each of the at least one mobile vertical farming unit 510, the at least one agricultural robot 520 and the supply station 530 is operatively connected to the controller 540. It will be appreciated that the connection is a wireless connection. The skilled addressee will appreciate that various communication protocols may be used for enabling such wireless connection. In one embodiment, the wireless connection is achieved using a Wi-Fi connection. In an alternative embodiment, the wireless connection is achieved using a cellular connection through LTE.

It will be appreciated that at least one of the at least one mobile vertical farming unit 510 and the at least one agricultural robot 520 may be further equipped with at least one sensor suitable for providing data indicative of a parameter of a vertical farming unit of the at least one vertical farming unit 510 to the controller 540. In one or more embodiments, the at least one sensor is selected from a group consisting of temperature sensors, humidity sensors, light sensors, and nutrition sensors. Such sensors may provide data to the controller 540 to facilitate the monitoring and the managing of the system 500 by the controller 540. For instance, the data received by the controller 540 may be used to dispatch an agricultural robot to a given mobile vertical farming unit.

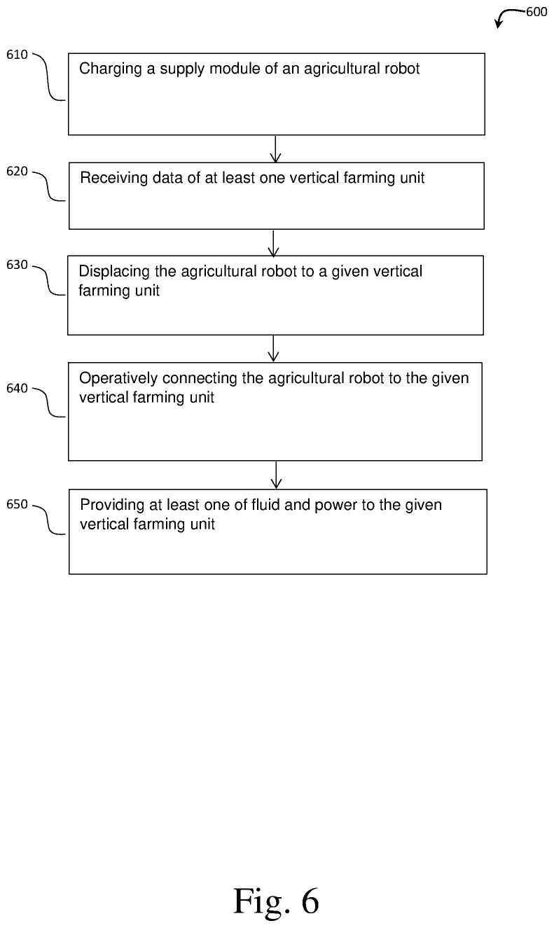

Now referring to FIG. 6, there is shown an embodiment of a method for autonomously supplying a vertical farming unit. In one embodiment, the vertical farming unit is a mobile vertical farming unit.

According to processing step 610, a supply module of an agricultural robot is charged. It will be appreciated that the supply module comprises a fluid providing unit and a power providing unit. It will be appreciated that the charging of the supply module of the agricultural robot comprises at least one of filling up a fluid reservoir and charging a power providing unit of the agricultural robot.

According to processing step 620, data of at least one mobile vertical farming unit is received.

In one or more embodiments, the data is received by a controller. In one or more embodiments, the data is wirelessly received by the controller. It will be appreciated that the data may be of various types. For instance and in accordance with one or more embodiments, the data is indicative that a replenishment of electric stores is required or that a removable battery is running low on energy. It will be appreciated that the data may also be indicative that fluid is required by a given mobile vertical farming unit. The skilled addressee will appreciate that the data may also be associated with other sensors located at a given mobile vertical farming unit, such as humidity sensors, light sensors or the like.

According to processing step 630, at least one agricultural robot is displaced to at least one corresponding vertical farming unit. It will be appreciated that the agricultural robot may be displaced according to various embodiments. In one or more embodiments, the at least one agricultural robot is displaced upon receipt of a given signal from a controller managing the system and operatively connected to the agricultural robot.

According to processing step 640, at least one agricultural robot is operatively connected to a corresponding given vertical farming unit. It will be appreciated that the at least one agricultural robot may be operatively connected to a corresponding given vertical farming unit according to various embodiments as explained above.

According to processing step 650, at least one of fluid and power is provided to the given vertical farming unit by the at least one agricultural robot. It will be appreciated that in the embodiment wherein power is provided, processing step 610 may comprise charging using power bank located on the supply module of the agricultural robot, or loading the given vertical farming unit with at least one charged removable battery located on the supply module of the agricultural robot.

An advantage of the agricultural robot disclosed herein is that it may reduce or eliminate the need for lengthy wiring and tubing systems from a static fluid and from the power sources by bridging the gap between static facilities and mobile vertical farming units, increasing the mobility and modularity of vertical farming units using mobile multi-shelf apparatuses within the greenhouse space as needed.

Another advantage of the agricultural robot disclosed herein is that it can travel along with a mobile vertical farming unit as the mobile vertical farming unit is being transported between locations, for example being shipped from a nursery to a retail location, in order to continue providing power for lighting and fluid for irrigation to plants even while during transport, improving freshness and optimizing growing time.

Another advantage of the agricultural robot disclosed herein is that it may be used to provide power and fluid to plants in the case of an outage, mitigating losses in event of an emergency.

Clause 1: An agricultural robot comprising:

a chassis comprising a plurality of ground-engaging mechanisms for propelling the robot in a direction of travel;

a supply module mounted on the chassis and comprising:
a fluid providing unit,
a power providing unit,
a supply interface operatively connected to the fluid providing unit and to the power providing unit and for providing at least one of fluid and power; and

a controller for operating the plurality of ground-engaging mechanisms and the supply interface.

Clause 2: The agricultural robot as claimed in clause 1, wherein the fluid providing unit comprises a fluid reservoir and the supply interface comprises a fluid outlet operatively connected to the fluid reservoir.

Clause 3: The agricultural robot as claimed in clause 2, wherein the supply interface further comprises a fluid inlet operatively connected to the fluid reservoir.

Clause 4: The agricultural robot as claimed in clause 2, further wherein the supply interface comprises a robotic arm comprising an end effector; further wherein the fluid outlet is mounted at the end effector of the robotic arm.

Clause 5: The agricultural robot as claimed in clause 1, wherein the power providing unit comprises a battery pack comprising a plurality of batteries and a power connection operatively connected to the battery pack for providing power from the battery pack.

Clause 6: The agricultural robot as claimed in clause 5, further wherein the supply interface comprises a robotic arm comprising an end effector; further wherein the power connection is mounted at the end effector of the robotic arm.

Clause 7: The agricultural robot as claimed in clause 1, further wherein the supply interface comprises at least one removable battery and a robotic arm sized and shaped for replacing a removable battery located in the vicinity of the agricultural robot with a given removable battery of the at least one removable battery.

Clause 8: The agricultural robot as claimed in clause 7, wherein the robotic arm comprises an end effector comprising a standardized docking connector; further wherein each of the removable battery comprises a standardized docking port compatible with said standardized docking connector.

Clause 9: The agricultural robot as claimed in clause 8, wherein the end effector further comprises guiding means for aligning the end effector with a given removable battery to manipulate.

Clause 10: The agricultural robot as claimed in clause 9, wherein the guiding means comprises two support parallel members rotationally mounted to the end effector and movable between a resting position wherein the two support parallel members are in a vertical plane and an operating position wherein the two support parallel members are in an horizontal plane.

Clause 11: The agricultural robot as claimed in clause 1, wherein the plurality of ground-engaging mechanisms comprise a plurality of motorized wheels.

Clause 12: The agricultural robot as claimed in clause 1, wherein the controller comprises a processing unit, at least one sensor and a wireless communication device; further wherein the at least one sensor and the wireless communication device are operatively connected to the processing unit.

Clause 13: The agricultural robot as claimed in clause 1, wherein the power providing unit further comprises a rotating platform for receiving a plurality of removable batteries, each facing a center of the rotating platform.

Clause 14: The agricultural robot as claimed in clause 1, wherein the power providing unit further comprises a collapsible multi-shelf rack receiving a plurality of removable batteries.

Clause 15: A system comprising:

at least one agricultural robot as claimed in clause 1;

at least one vertical farming unit comprising a supply interface corresponding to the supply interface of each of the at least one agricultural robot;

at least one sensor located on at least one of the at least one agricultural robot and at least one of the at least one vertical farming unit, the at least one sensor for providing data indicative of a parameter of a vertical farming unit of the at least one vertical farming unit; and

a controller operatively connected to the at least one agricultural robot and to the at least one sensor, the controller receiving data provided by the at least one sensor and dispatching an agricultural robot accordingly.

Clause 16: The system as claimed in clause 15, wherein the at least one sensor is selected from a group consisting of temperature sensors, humidity sensors, light sensors and nutrition sensors.

Clause 17: The system as claimed in any one of clauses 15 and 16, wherein the controller is wirelessly connected to the at least one agricultural robot and to the at least one sensor.

Clause 18: The system as claimed in clause 15, wherein the at least one agricultural robot, the at least one vertical farming unit and the at least one sensor are located on an operating site while the controller is remotely located from the operating site.

Clause 19: The system as claimed in any one of clauses 15 to 18, further comprising a supply station for supplying an agricultural robot of the at least one agricultural robot with at least one resource.

Clause 20: The system as claimed in clause 19, wherein the at least one resource comprises power; further wherein the supply station comprises a power source.

Clause 21: The system as claimed in clause 20, wherein the power source comprises a charging station for charging power banks.

Clause 22: The system as claimed in clause 20, wherein the power source comprises a charging station for charging at least one removable battery to be carried by a given agricultural robot.

Clause 23: The system as claimed in any one of clauses 19 to 20, wherein the at least one resource comprises fluid; further wherein the supply station comprises a fluid source.

Clause 24: The system as claimed in clause 23, wherein the fluid source comprises a fluid reservoir.

Clause 25. A method for autonomously supplying a vertical farming unit, the method comprising:

charging a supply module of an agricultural robot as claimed in clause 1;

receiving data of at least one vertical farming unit;

displacing the agricultural robot to a given vertical farming unit of the at least one vertical farming unit;

operatively connecting the agricultural robot to the given vertical farming unit; and

providing at least one of fluid and power to the given vertical farming unit.

Clause 26: The method as claimed in clause 25, wherein said charging of the supply module of the agricultural robot comprises at least one of filing up a fluid reservoir and charging a power providing unit of the agricultural robot.

Clause 27: The method as claimed in clause 25, wherein the data of the at least one vertical farming unit is wireless received by a controller.

Clause 28: The method as claimed in clause 25, wherein the agricultural robot is displaced to a given vertical farming unit upon receipt of a given signal from a controller operatively connected to the agricultural robot.

Clause 29: The method as claimed in clause 25, wherein the providing of at least one of fluid and power to the given vertical farming unit comprises charging using a power bank located on the supply module of the agricultural robot.

Clause 30: The method as claimed in clause 25, wherein the providing of at least one of fluid and power to the given vertical farming unit comprises loading the given vertical farming unit with at least some charged removable battery located on the supply module of the agricultural robot.

While specific embodiments have been described and illustrated, such embodiments should be considered illustrative only and not limiting as the disclosed embodiments as construed in accordance with the accompanying claims.

1. A robot comprising:
a chassis comprising a plurality of ground-engaging mechanisms for propelling the robot in a direction of travel;
a supply module mounted on the chassis and comprising:
a resource providing unit,
a supply interface operatively connected to the resource providing unit for providing a resource; and
a controller for operating the plurality of ground-engaging mechanisms and the supply interface.

2. The robot as claimed in claim 1, wherein the resource comprises a fluid, and the resource providing unit comprises a fluid reservoir and the supply interface comprises a fluid outlet operatively connected to the fluid reservoir.

3. The al robot as claimed in claim 2, wherein the supply interface further comprises a fluid inlet operatively connected to the fluid reservoir.

4. The robot as claimed in claim 2, further wherein the supply interface comprises a robotic arm comprising an end effector; further wherein the fluid outlet is mounted at the end effector of the robotic arm.

5. The robot as claimed in claim 1, wherein the resource comprises electrical power, and the resource providing unit comprises a battery pack comprising a plurality of batteries and a power connection operatively connected to the battery pack for providing power from the battery pack.

6. The robot as claimed in claim 5, further wherein the supply interface comprises a robotic arm comprising an end effector; further wherein the power connection is mounted at the end effector of the robotic arm.

7. The robot as claimed in claim 1, further wherein the supply interface comprises at least one removable battery and a robotic arm sized and shaped for replacing a removable battery located in the vicinity of the robot with the at least one removable battery.

8. The robot as claimed in claim 7, wherein the robotic arm comprises an end effector comprising a standardized docking connector; further wherein each of the removable battery comprises a standardized docking port compatible with said standardized docking connector.

9. The robot as claimed in claim 8, wherein the end effector further comprises guiding means for aligning the end effector with the removable battery to manipulate.

10. The robot as claimed in claim 9, wherein the guiding means comprises two support parallel members rotationally mounted to the end effector and movable between a resting position wherein the two support parallel members are in a vertical plane and an operating position wherein the two support parallel members are in a horizontal plane.

11. (canceled)

12. The robot as claimed in claim 1, wherein the controller comprises a processing unit, at least one sensor and a wireless communication device; further wherein the at least one sensor and the wireless communication device are operatively connected to the processing unit.

13. The robot as claimed in claim 5, wherein the resource providing unit further comprises a rotating platform for receiving a plurality of removable batteries, each facing a center of the rotating platform.

14. The robot as claimed in claim 5, wherein the resource providing unit further comprises a collapsible multi-shelf rack receiving a plurality of removable batteries.

15. A system comprising:
at least one robot as claimed in claim 1;
at least one vertical farming unit comprising a supply interface corresponding to the supply interface of each of the at least one robot;
at least one sensor located on at least one of the at least one robot and at least one of the at least one vertical farming unit, the at least one sensor for providing data indicative of a parameter of a vertical farming unit of the at least one vertical farming unit; and
a controller operatively connected to the at least one robot and to the at least one sensor, the controller receiving data provided by the at least one sensor and dispatching a robot accordingly.

16. The system as claimed in claim 15, wherein the at least one sensor comprises at least one of a temperature sensor, a humidity sensor, a light sensor, and a nutrition sensor.

17. The system as claimed in claim 15, wherein the controller is wirelessly connected to the at least one robot and to the at least one sensor.

18. The system as claimed in claim 15, wherein the at least one robot, the at least one vertical farming unit and the at least one sensor are located on an operating site while the controller is remotely located from the operating site.

19. The system as claimed in claim 15, further comprising a supply station for supplying a robot of the at least one robot with at least one resource.

20. The system as claimed in claim 19, wherein the at least one resource comprises power and wherein the supply station comprises a power source including a charging station for charging a power bank or for charging at least one removable battery to be carried by a robot of the at least one robot.

21.-22. (canceled)

23. The system as claimed in claim 19, wherein the at least one resource comprises fluid and wherein the supply station comprises a fluid source comprising a fluid reservoir.

24. (canceled)

25. A method for autonomously supplying a vertical farming unit, the method comprising:
charging a supply module of a robot as claimed in claim 1;
receiving data of at least one vertical farming unit;
displacing the robot to a vertical farming unit of the at least one vertical farming unit;
operatively connecting the robot to the vertical farming unit; and
providing a resource to the vertical farming unit.

26.-30. (canceled)
